(19) United States
(12) Patent Application Publication
(10) Pub. No.: US 2025/0278592 A1
(43) Pub. Date: Sep. 4, 2025

(54) INFORMATION PROCESSING APPARATUS AND NON-TRANSITORY COMPUTER-READABLE STORAGE MEDIUM STORING INFORMATION PROCESSING PROGRAM

(71) Applicant: SEIKO EPSON CORPORATION, Tokyo (JP)

(72) Inventor: Shusuke KIBUNE, MATSUMOTO-SHI (JP)

(21) Appl. No.: 19/066,200

(22) Filed: Feb. 28, 2025

(30) Foreign Application Priority Data
Mar. 1, 2024 (JP) 2024-031360

(51) Int. Cl. G06K 15/00

(52) U.S. Cl. CPC G06K 15/407; G06K 15/002

(57) ABSTRACT

Provided is an information processing apparatus including: a color information acquisition unit that acquires, based on input to a usage amount specification screen that specifies a usage amount of a color material, the usage amount of the color material when a reference color is printed by a printing apparatus; and a warning unit that displays no warning regarding reproducibility of the reference color when the usage amount of the color material is a first usage amount, and displays a warning regarding reproducibility of the reference color when the usage amount of the color material is a second usage amount greater than the first usage amount.

The present application is based on, and claims priority from JP Application Serial Number 2024-031360, filed Mar. 1, 2024, the disclosure of which is hereby incorporated by reference herein in its entirety.

### BACKGROUND

### 1. Technical Field

The present disclosure relates to an information processing apparatus and a non-transitory computer-readable storage medium storing an information processing program.

### 2. Related Art

Traditionally, a configuration is known in which a color chart including multiple patches is printed, and color adjustment is performed based on the color chart. For example, Japanese Patent No. 7314628 discloses a technique in which the Lab value and CMYK value of a center patch can be input, and multiple patches with altered Lab values relative to the center patch are printed on a color chart.

In the related art, although the usage amount of color materials can be specified by CMYK values, there is a limit to the usable amount of color materials when printing on a print medium. For example, if the usage amount is excessive, the accuracy of conversion to color values (Lab values, etc.) corresponding to the usage amount may decrease.

### SUMMARY

An information processing apparatus according to an aspect includes: a color information acquisition unit that acquires, based on input to a usage amount specification screen that specifies a usage amount of a color material, the usage amount of the color material when a reference color is printed by a printing apparatus; and a warning unit that displays no warning regarding reproducibility of the reference color when the usage amount of the color material is a first usage amount, and displays a warning regarding reproducibility of the reference color when the usage amount of the color material is a second usage amount greater than the first usage amount.

An information processing apparatus according to another aspect includes: a color information acquisition unit that acquires, based on input to a usage amount specification screen that specifies a usage amount of a color material, the usage amount of the color material when a reference color is printed by a printing apparatus; and a control unit that enables execution of printing of the reference color when the usage amount of the color material is a first usage amount, and prohibits printing of the reference color when the usage amount of the color material is a second usage amount greater than the first usage amount.

A non-transitory computer-readable storage medium storing an information processing program, according to still another aspect, the program causing a computer to function as: a color information acquisition unit that acquires, based on input to a usage amount specification screen that specifies a usage amount of a color material, the usage amount of the color material when a reference color is printed by a printing apparatus; and a warning unit that displays no warning regarding reproducibility of the reference color when the usage amount of the color material is a first usage amount, and displays a warning regarding reproducibility of the reference color when the usage amount of the color material is a second usage amount greater than the first usage amount.

A non-transitory computer-readable storage medium storing an information processing program, according to still another aspect, the program causing a computer to function as: a color information acquisition unit that acquires, based on input to a usage amount specification screen that specifies a usage amount of a color material, the usage amount of the color material when a reference color is printed by a printing apparatus; and a control unit that enables execution of printing of the reference color when the usage amount of the color material is a first usage amount, and prohibits printing of the reference color when the usage amount of the color material is a second usage amount greater than the first usage amount.

### BRIEF DESCRIPTION OF THE DRAWINGS

FIG. 1 is a diagram illustrating a usage example of the information processing apparatus.

FIG. 2 is a block diagram of the colorimetric instrument.

FIG. 3 is a block diagram of the printing apparatus.

FIG. 4 is a block diagram of the information processing apparatus.

FIG. 5 is a flowchart of the print control process.

FIG. 6 is a diagram illustrating an example of the usage amount specification screen.

FIG. 7 is a diagram illustrating an example of the creation condition specification screen.

FIG. 8 is a diagram illustrating an arrangement example of color patches.

FIG. 9 is a block diagram of the information processing apparatus.

FIG. 10 is a diagram illustrating an example of the usage amount specification screen.

FIG. 11 is a diagram illustrating an example of the creation condition specification screen.

### DESCRIPTION OF EMBODIMENTS

Here, embodiments of the present disclosure will be described below in the following order:
(1) System Configuration
(1-1) Configuration of Colorimetric Instrument
(1-2) Configuration of Printing Apparatus
(1-3) Configuration of Information Processing Apparatus
(2) Print Control Process
(3) Other Embodiments, etc.

### (1) SYSTEM CONFIGURATION

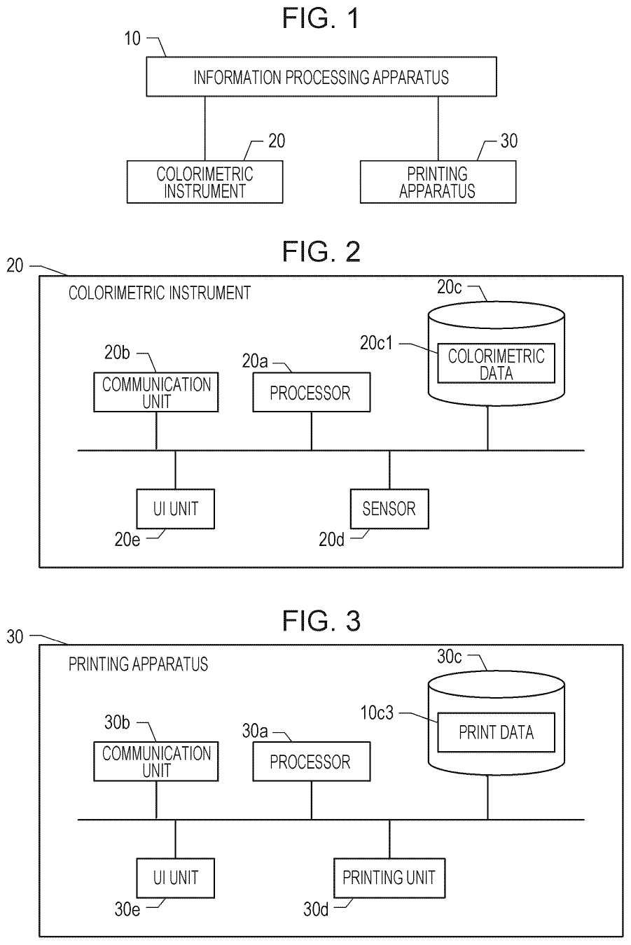

FIG. 1 is a diagram illustrating a usage example of the information processing apparatus 10 according to an embodiment. In the present embodiment, the information processing apparatus 10 is connected to a colorimetric instrument 20 and a printing apparatus 30. The information processing apparatus 10 is an apparatus that performs color conversion on image data to generate print data and causes the printing apparatus 30 to execute printing based on the print data. The user can also specify a desired color and print a color chart; and after confirming the color reproducibility based on the color chart, the user can execute printing of the desired image. In the present embodiment, the user can specify a reference color included in the color chart by measuring a color sample using the colorimetric instrument 20. The color chart includes a patch printed based on a color value indicating the reference color and patches printed based on the color values of surrounding colors generated by varying the reference color.

### (1-1) Configuration of Colorimetric Instrument

FIG. 2 is a block diagram illustrating the configuration of the colorimetric instrument 20. The colorimetric instrument 20 includes a processor 20a, a communication unit 20b, non-volatile memory 20c, a sensor 20d, and a UI unit 20e. The processor 20a includes an unillustrated CPU, ROM, RAM, etc., executes a control program recorded in the non-volatile memory 20c, and can control each unit of the colorimetric instrument 20.

The processor 20a may be configured with a single chip, multiple chips, or as an SoC with various functional blocks. For example, an ASIC may be employed instead of the CPU, or a configuration in which the CPU and ASIC cooperate may be employed. When each apparatus in the present embodiment includes a processor, the processor can be implemented in various ways, similar to the processor 20a.

The communication unit 20b includes a communication interface for communicating with the information processing apparatus 10 according to various wired or wireless communication protocols. The sensor 20d is a device that irradiates a colorimetric target with light of a predetermined color temperature and detects the spectral distribution of reflected light. The processor 20a acquires a color value (e.g., CIELAB value, HSV value, XYZ value, etc.) indicating the color of the colorimetric target by a color in a device-independent color space, based on the result read by the sensor 20d. Hereinafter, the description will continue assuming that the color value is an HSV value (hue value, saturation value, and brightness value).

In the present embodiment, the user can specify the color value of the reference color based on the colorimetric result of the colorimetric instrument 20. In the present embodiment, a sample color is measured by the colorimetric instrument 20 to specify the color value of the reference color. The sample color may be a color printed on various objects; however, here, it is assumed that a medium colored to be a sample color is measured. Thus, according to the configuration in which the reference color is specified by the colorimetric result of the colorimetric instrument 20, the reference color can be accurately specified.

In the present embodiment, when color matching is performed using the color chart, printing is performed so that the color value is reproduced for a specific single color; furthermore, the printing apparatus 30 can print colors similar to the color-matched color as colors reflecting the result of the color matching. Thus, in order to reflect the color matching result in multiple colors, in the present embodiment, the image data is composed of one or more layers.

In the present embodiment, each layer is called a plate. The number of color channels that can be used in each plate is predetermined; in the present embodiment, there is a process color plate that can be used by desirably varying any color over the entire range of gradation values, and a spot color plate for printing the color matched based on the color chart. The process color plate is a plate in which all usable colors can be desirably varied and used, and examples include image data in which all RGB (R: red, G: green, B: blue) can be used and image data in which all CMYK (C: cyan, M: magenta, Y: yellow, K: black) can be used.

Spot color plate image data consists of a representative color, which is the color representing the spot color plate, and colors with different densities from the representative color. In the spot color plate image data, the representative color is specified by each gradation value of RGB or CMYK in the header, and the color of each pixel is specified by a gradation value representing the relative density difference from the representative color. For example, when expressing the gradation value of a spot color plate with a 1-channel 8-bit gradation value, a gradation value of 128 matches the representative color, pixels with gradation values greater than 128 are considered darker than the representative color, and pixels with gradation values less than 128 are considered lighter than the representative color. A gradation value of 255 indicates the color when the representative color is made as dark as possible, and a gradation value of 0 indicates the color when the representative color is made as light as possible.

In the present embodiment, the representative color of the spot color plate is determined by the color matched using the color chart. That is, the user specifies the representative color by specifying one of the patches printed on the color chart. In the present embodiment, when a color sample is measured by the colorimetric instrument 20 to specify the reference color included in the color chart, the colorimetric data 20c1 indicating the color value, which is the colorimetric result, is stored in the non-volatile memory 20c.

The UI unit 20e is a button or the like provided on the housing of the colorimetric instrument 20. The user can instruct the start of color sample measurement, etc., by operating the UI unit 20e. The processor 20a receives the user's instruction based on the output information of the UI unit 20e.

### (1-2) Configuration of Printing Apparatus

FIG. 3 is a block diagram illustrating the configuration of the printing apparatus 30. The printing apparatus 30 includes a processor 30a, a communication unit 30b, non-volatile memory 30c, a printing unit 30d, and a UI unit 30e. The processor 30a includes an unillustrated CPU, ROM, RAM, etc., executes a control program recorded in the non-volatile memory 30c, and can control each unit of the printing apparatus 30.

The communication unit 30b includes a communication interface for communicating with the information processing apparatus 10 according to various wired or wireless communication protocols. The communication unit 30b may also include an interface for communicating with various removable memories attached to the printing apparatus 30.

The printing unit 30d includes actuators and various devices, sensors, drive circuits, mechanical parts, etc., for executing printing on a print medium. The sensors include sensors that detect various detection targets that can vary in the printing apparatus 30. Examples include a sensor that detects the remaining amount of print medium and a sensor that detects the remaining amount of each color material used for printing. In the present embodiment, the printing unit 30d includes a mechanism for recording color materials of predetermined colors on a print medium. In the present embodiment, the printing unit 30d records on the print medium using CMYKGGyROr (C: cyan, M: magenta, Y: yellow, K: black, G: green, Gy: gray, R: red, Or: orange) color materials. Hereinafter, it is assumed that the printing apparatus 30 is an ink jet printer that uses ink as the color material, but the printing method is not limited to the ink jet method. The color materials used for recording are not limited to the CMYKGGyROr combination and can be varied as appropriate.

The printing unit 30d can print on print media of various sizes. That is, the printing unit 30d includes a storage unit for storing print media of various sizes and can transport and print the stored print media.

The UI unit 30e is composed of an input unit such as buttons and a touch panel provided on the housing of the printing apparatus 30 and a display unit for displaying various information. Based on the information displayed on the display unit of the UI unit 30e, the user can operate the input unit to issue various instructions.

The processor 30a of the printing apparatus 30 performs printing based on the print data 10c3 transmitted from the information processing apparatus 10. That is, when printing is performed, the print data 10c3 is transmitted along with a print instruction from the information processing apparatus 10 and stored in the non-volatile memory 30c. Based on the print data 10c3, the processor 30a controls the printing unit 30d, etc., and executes printing on the print medium stored in the printing unit 30d.

### (1-3) Configuration of Information Processing Apparatus

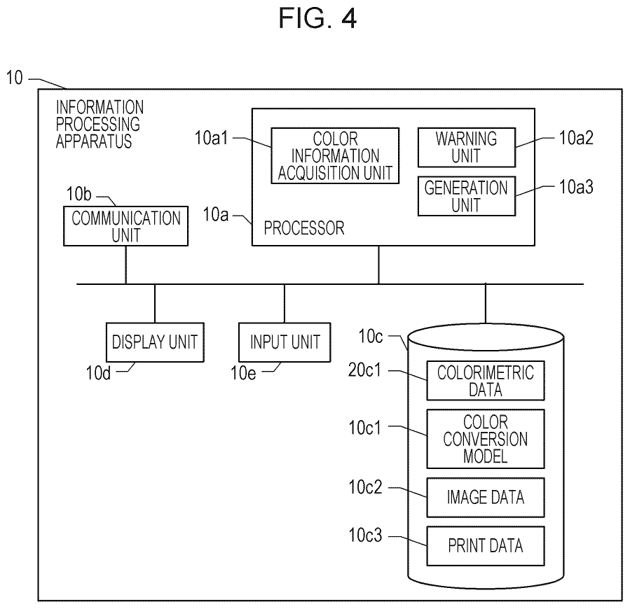

FIG. 4 is a block diagram illustrating the configuration of the information processing apparatus 10. In the present embodiment, the information processing apparatus 10 includes a processor 10a, a communication unit 10b, non-volatile memory 10c, a display unit 10d, and an input unit 10e. The processor 10a includes an unillustrated CPU, ROM, RAM, etc., executes various programs recorded in the non-volatile memory 10c, and can control each unit of the information processing apparatus 10, the colorimetric instrument 20, etc. In other words, the processor 10a functions as a control unit.

The communication unit 10b includes a communication interface for communicating with the colorimetric instrument 20 and the printing apparatus 30 according to various wired or wireless communication protocols. The communication unit 10b may also include an interface for communicating with various removable memories attached to the information processing apparatus 10.

Various data can be stored in the non-volatile memory 10c. In the present embodiment, colorimetric data 20c1, a color conversion model 10c1, image data 10c2, and print data 10c3 are stored in the non-volatile memory 10c. The colorimetric data 20c1 is data transmitted from the colorimetric instrument 20 and indicates the color value (HSV value), which is the colorimetric result of the sample color.

The color conversion model 10c1 is data for color-converting image data and associates colors in a device-independent color space with colors in a device-dependent color space. In the present embodiment, the color conversion model 10c1 includes an input-side model that performs input-side color conversion and an output-side model that performs output-side color conversion.

The input-side model that performs input-side color conversion is a model that converts RGB gradation values or CMYK values indicating colors in a device-dependent color space and HSV values indicating colors in a device-independent color space into each other. In the present embodiment, a model for converting RGB gradation values or CMYK values to HSV values is machine-learned. A model for converting HSV values to RGB gradation values or CMYK values is also machine-learned based on the training data. These learned models are the input-side models. The form of the input-side model may be various; for example, it may be a neural network that converts input values to output values, or it may be composed of a machine-learned model and an optimization module that performs optimization, similar to the output-side model described later. It is also possible to use an existing ICC profile instead of the input-side model in the color conversion model 10c1. This ICC profile is a lookup table used for various devices; for example, in the present embodiment, a display profile corresponding to a display used as the display unit 10d can be used.

The output-side model that performs output-side color conversion is a model that converts colors in a device-dependent color space, i.e., CMYKGGyROr gradation values indicating the color materials used by the printing apparatus 30, and HSV values indicating colors in a device-independent color space into each other. In the present embodiment, the output-side model includes a model for converting the usage amounts of the color materials to color values (hereinafter referred to as a color prediction model) and an optimization module.

Here, the color prediction model includes a model for converting CMYKGGyROr gradation values indicating the usage amounts of the color materials into spectral reflectance. This model is generated, for example, by preparing training data in which CMYKGGyROr gradation values and spectral reflectance are associated in advance and machine-learning a neural network that converts CMYKGGyROr gradation values into spectral reflectance based on the training data. The spectral reflectance can be specified, for example, by measuring a color printed based on the CMYKGGyROr gradation values using the colorimetric instrument 20. The spectral reflectance can be converted into a color value by using a known calculation method, and the color prediction model also includes this conversion. Therefore, the color prediction model is a model that converts CMYKGGyROr gradation values into color values via spectral reflectance.

The optimization module is used to convert a color value to be converted into usage amounts of color materials using the color prediction model. Specifically, the optimization module converts a color value to be converted into provisional usage amounts of color materials, inputs them to the color prediction model, and converts them into a color value. The color value obtained by this conversion is called a predicted color value. If the color difference between the predicted color value and the color value to be converted is less than or equal to a reference value, the optimization module considers that the two match. In this case, the color value to be converted is converted into the provisional usage amounts of the color materials.

On the other hand, if the color difference between the predicted color value and the color value to be converted is greater than the reference value, the optimization module corrects the provisional usage amounts of the color materials. Furthermore, the optimization module inputs the corrected provisional usage amounts of the color materials to the color prediction model and determines whether or not the color difference between the obtained predicted color value and the color value to be converted is less than or equal to the reference value. The optimization module repeats the above process until the color difference between the predicted color value and the color value to be converted becomes less than or equal to the reference value. When the color difference between the predicted color value and the color value to be converted becomes less than or equal to the reference value, the optimization module considers that the color value to be converted has been converted into the provisional usage amounts of the color materials. As described above, according to the output-side model of the color conversion model 10c1, CMYKGGyRor gradation values can be converted into HSV values by the color prediction model. Also, HSV values can be converted into CMYKGGyROr gradation values by the color prediction model and the optimization module.

Further, in the present embodiment, constraint conditions for restricting the color materials used in the printing apparatus 30 can be imposed during conversion by the output-side model of the color conversion model 10c1. Specifically, when converting a color value to be converted into usage amounts of color materials, the optimization module sets provisional usage amounts of the color materials. At this time, it can be set so as not to use specific color materials. For example, when at least one of the CMYKGGyRor color materials is not used, the usage amount of that color material is fixed at 0. With this configuration, the optimization module specifies provisional usage amounts of the color materials such that the color difference between the predicted color value and the color value to be converted is less than or equal to the reference value while the usage amount of the color material is fixed at 0. Therefore, when provisional usage amounts of the color materials are specified such that the color difference between the predicted color value and the color value to be converted is less than or equal to the reference value, a color value can be converted into usage amounts of the color materials under the constraint of not using specific color materials. When converting usage amounts of color materials into a color value, the usage amounts of the unused color materials may be set to 0 and input to the prediction model.

The configuration in which color conversion is performed by the color conversion model 10c1 is merely an example, and color conversion may naturally be performed by various functions or lookup tables. However, by using the color conversion model 10c1, the resources required for the information processing apparatus 10 and the man-hours required for data generation can be reduced. For example, a lookup table is data in which HSV values and colors in a device-dependent color space are associated for multiple representative points, and the number of representative points is generally very large. In particular, when associating CMYKGGyRor gradation values with HSV values, the CMYKGGyROr gradation values are 8-dimensional coordinate values, and it is necessary to associate a large number of points in the 8-dimensional coordinate space with 3-dimensional HSV space coordinate values, resulting in a very large amount of data. In the case of a lookup table, in order to restrict color materials, it is necessary to create a lookup table for all cases after the restriction. For example, when restricting cyan or magenta, it is necessary to create a lookup table for each case.

On the other hand, although a large amount of data may be required when creating a learned model obtained by machine learning, the amount of data is generally less than that of a lookup table. Further, in the present embodiment, it is not necessary to create different learned models for each condition in order to restrict color materials. Therefore, assuming a situation where there are multiple conditions such that specific color materials are not used and a color conversion model 10c1 and a lookup table corresponding to each condition are prepared, the data amount can be reduced when preparing the color conversion model 10c1 compared to when preparing the lookup table.

The task of creating a lookup table generally requires a very large number of man-hours. The task of preparing lookup tables for each condition requires an extremely large number of man-hours. However, to generate the output-side model of the color conversion model 10c1 as in the present embodiment, it is not necessary to generate different models for each condition. Therefore, the color conversion model 10c1 can be generated with a smaller configuration than creating a lookup table.

When generating the output-side model of the color conversion model 10c1 as described above, training data used for learning the color prediction model is prepared for gradation values within a practical range for the usage amounts of the color materials. That is, if the usage amounts of the color materials are excessive, wrinkles may occur on the print medium, or the color materials may flow, which may degrade print quality. Therefore, the usable amount per unit area on the print medium is limited, and the range of gradation values that fall within the limit is specified in advance for the combination of CMYKGGyROr gradation values.

The training data is data in which CMYKGGyROr gradation values and HSV values are associated for combinations of gradation values that fall within the limit. Therefore, the color conversion model 10c1 after machine learning may not accurately perform color conversion for gradation values outside the limit. That is, in the present embodiment, training data is not prepared for all possible combinations of values that can be set as CMYKGGyROr gradation values, but training data is prepared for gradation values within a predetermined limited range so that print quality does not deteriorate. The range of CMYKGGyROr gradation values for which training data is prepared is referred to as a learning range.

In the present embodiment, the index for determining whether the usage amount of the color materials is the second usage amount subject to warning or the first usage amount not subject to warning is determined according to the learning range of the output-side model of the color conversion model 10c1. That is, in the present embodiment, when the CMYKGGyROr gradation value corresponding to the usage amount of the color materials is outside the learning range, it is considered to be the second usage amount.

The image data 10c2 is data indicating an image to be printed. As described above, the image data 10c2 includes image data of multiple plates. In the present embodiment, it is assumed that there is at least one process color plate and one spot color plate. Therefore, the image data 10c2 includes data of the process color plate in which the color of each pixel is specified by an RGB gradation value or a CMYK gradation value. The image data 10c2 also includes data of the spot color plate, including an RGB gradation value or a CMYK gradation value of a representative color specified in the header and a gradation value for each pixel indicating a relative density difference from the representative color. Naturally, this configuration is merely an example, and the number of plates that can exist is not limited, and multiple plates may exist or a specific plate may not exist. The image data 10c2 includes information indicating a weighting factor for superimposing each plate, and an image to be printed is specified by superimposing the data of each plate with the weighting factor.

The print data 10c3 is data for causing the printing apparatus 30 to execute printing. In the present embodiment, the processor 10a performs image processing including color conversion by the color conversion model 10c1 based on the image data 10c2 to generate the print data 10c3. Specifically, the image data 10c2 includes a printer description language, and the processor 10a performs rendering processing including analysis and conversion processing into raster data based on the printer description language. After rasterization, the processor 10a performs color conversion of the raster data using the color conversion model 10c1 and acquires the usage amount of each color material necessary to print the color of each pixel. For example, in the process color plate, the processor 10a converts the RGB value or CMYK value of each pixel into an HSV value by the input-side model or the ICC profile and converts the HSV value of each pixel into a CMYKGGyROr gradation value by the output-side model. In the spot color plate, the processor 10a acquires the CMYKGGyROr gradation value of each pixel based on the CMYKGGyROr gradation value of the representative color and the gradation value of each pixel. The processor 10a performs page layout determination processing, halftone processing, etc. on the print medium to generate the print data 10c3. When the print data 10c3 is generated, the print data 10c3 is transmitted to the printing apparatus 30, and printing is performed.

The display unit 10d is a display device that displays arbitrary images. The input unit 10e is a device on which the user performs input operations. The information processing apparatus 10 can be implemented in various ways and may be a stationary computer or a portable computer. In the former case, the display unit 10d can be configured, for example, with a display independent from the computer main body, and the input unit 10e can be configured, for example, with a keyboard, mouse, etc., independent from the computer main body. In the latter case, the display unit 10d and the input unit 10e can be configured, for example, with a touch panel display integrated with the computer main body. In any case, the user can input the user's intention by operating the input unit 10e while visually recognizing images and characters displayed on the display unit 10d. Hereinafter, in the present embodiment, the description will be given assuming that the information processing apparatus 10 is a stationary computer.

The processor 10a can execute an unillustrated information processing program. The information processing program according to the present embodiment displays a screen for setting when printing a spot color plate so as to reproduce the sample color measured by the colorimetric instrument 20 on the display unit 10d. The user can use this screen to print a color chart including patches of the reference color and surrounding colors, and the user can specify the representative color of the spot color plate by selecting a patch on the color chart.

In the present embodiment, the information processing program has a function for performing color matching using the color chart. When the information processing program is executed, the processor 10a functions as a color information acquisition unit 10a1, a warning unit 10a2, and a generation unit 10a3.

The color information acquisition unit 10a1 has a function of acquiring the usage amounts of color materials when the reference color is printed by the printing apparatus 30 based on the input to the usage amount specification screen that specifies the usage amounts of the color materials. It is difficult for a user to estimate the usage amounts of the color materials when printing a specific reference color by the printing apparatus 30 while the user is assuming the reference color. Therefore, in the present embodiment, it is possible to display the usage amounts of the color materials for reproducing the colorimetric results as initial values by measuring a color sample of the reference color using the colorimetric instrument 20. Details of the usage amount specification screen will be described later.

Therefore, the user measures the sample color using the colorimetric instrument 20. The color information acquisition unit 10a1 acquires the color value (HSV value) of the sample color measured by the colorimetric instrument 20 and converts the color value into the usage amount of each color material by the output-side model of the color conversion model 10c1 to consider it as an initial value. The HSV value is a value of the device-independent color space. The color information acquisition unit 10a1 controls the display unit 10d to display the usage amount specification screen and causes the initial value of the usage amount to be displayed on the usage amount specification screen. The user can correct the usage amounts displayed on the usage amount specification screen and restrict the color materials to be used, and the user can specify the desired usage amounts of the desired color materials. The color specified in this way is the reference color, and the first and second usage amounts, which are examples of the usage amounts of the color materials, are values that may be specified by the user via the usage amount specification screen.

When the reference color is specified, the user specifies a parameter to be varied among the parameters that specify the reference color. The parameter to be varied is called a variation parameter. The variation parameter may be various parameters, and in the present embodiment, the user can select three types of variation parameters from among the hue value (H value), the saturation value (S value), the brightness value (V value), and the usage amount of the color materials.

The user further specifies a variation range of values in the variation parameter. The color information acquisition unit 10a1 generates surrounding colors by varying the value of the variation parameter among the values of the parameters of the reference color according to the variation range. The number of surrounding colors generated according to the variation range may be fixed or may be specified by the user. When the usage amount of the color materials is included in the variation parameters, the color information acquisition unit 10a1 converts the usage amount into a color value based on the output-side model of the color conversion model 10c1. According to the above configuration, the user can generate surrounding colors by varying the reference color in a desired manner, and the color values of the surrounding colors can be specified. Details of the creation condition specification screen for receiving the designation of the variation parameter and the designation of the variation range from the user will be described later.

When the color values of the reference color and surrounding colors are specified, each color is considered to be a color value indicating the color of multiple color patches. That is, according to the above processing, the color values of multiple color patches consisting of the reference color and the surrounding colors are acquired.

The warning unit 10a2 has a function of displaying a warning when the usage amount of the color materials when printing the reference color by the printing apparatus 30, which is acquired by the color information acquisition unit 10a1, is excessive and the reproducibility of the reference color may decrease. Specifically, the warning unit 10a2 displays no warning regarding the reproducibility of the reference color when the usage amount of the color materials when printing the reference color by the printing apparatus 30 is the first usage amount. On the other hand, when the usage amount of the color materials when printing the reference color by the printing apparatus 30 is the second usage amount greater than the first usage amount, the warning unit 10a2 controls the display unit 10d to display a warning regarding the reproducibility of the reference color.

In the present embodiment, whether or not the reproducibility of the reference color can decrease is evaluated by the usage amounts of the color materials. Therefore, in the present embodiment, a threshold value for determining whether or not the usage amounts of the color materials are excessive is set in advance. When the usage amounts of the color materials are greater than the threshold value, that is, when the usage amount is the second usage amount, the warning unit 10a2 causes the display unit 10d to display a warning. When the usage amounts of the color materials are less than the threshold value, that is, when the usage amount is the first usage amount, the warning unit 10a2 does not cause the display unit 10d to display a warning.

As described above, the threshold value for determining whether or not the usage amount of the color materials is the second usage amount, which is subject to warning, is determined according to the learning range of the output-side model of the color conversion model 10c1. That is, in the present embodiment, if the CMYKGGyROr gradation values corresponding to the usage amounts of the color materials are outside the learning range, they are considered as the second usage amount. As described above, in the present embodiment, training data is not prepared for all possible combinations of values that can be set as CMYKGGyROr gradation values, but the gradation values of the data prepared as training data are limited to gradation values within a predetermined learning range.

Therefore, if the gradation values are within the learning range, they can be accurately converted by the output-side model of the color conversion model 10c1, but if they are outside the learning range, they cannot be accurately converted by the output-side model of the color conversion model 10c1. Therefore, in the present embodiment, gradation values corresponding to the boundary between the inside and outside of the learning range are specified in advance, and a threshold value is determined in advance for the usage amounts of color materials corresponding to the gradation values.

A threshold value may be set for each of multiple color materials used by the printing apparatus 30 or for the total usage amount. In the present embodiment, a threshold value for determining whether or not each color material is outside the learning range when used alone and a threshold value for determining whether or not the total usage amount of the color materials is outside the learning range are determined in advance. According to the above configuration, it is possible to determine whether or not it is outside the learning range, that is, whether or not the color reproducibility is low, with a simple configuration. The user can also easily recognize whether or not the color reproducibility is low.

The generation unit 10a3 has a function of generating the print data 10c3 for printing the color chart. Specifically, the generation unit 10a3 generates the print data 10c3 for printing a color chart including the surrounding colors, which are colors generated by varying the value of the variation parameter in the reference color, and the reference color. That is, the generation unit 10a3 generates the print data 10c3 for printing the color chart including the reference color and the surrounding colors and stores it in the non-volatile memory 10c. In the present embodiment, the generation unit 10a3 generates the print data 10c3 so that color patches for which the color difference between the color values indicating the reference color and surrounding colors and the color values indicating the colors of the printed color patches is greater than or equal to a predetermined value can be distinguished from color patches for which the color difference is less than the predetermined value. Specifically, the generation unit 10a3 generates print data 10c3 so that the color patches where the color difference is greater than or equal to the predetermined value are surrounded by a dashed frame for warning that the color reproducibility is low. The color patches where the color difference is less than the predetermined value are not surrounded by a dashed frame. In the present embodiment, the print data 10c3 is generated so that a character string indicating the identification information of the color patch is printed in association with each color patch. Specific examples of such color patches will be described later.

When the user issues a print instruction while the print data 10c3 is generated, the processor 10a transmits the print data 10c3 to the printing apparatus 30 via the communication unit 10b. The printing apparatus 30 receives the print data 10c3 via the communication unit 30b and executes printing based on the print data 10c3. As a result, the color chart including the reference color and surrounding colors is printed. The user compares the color patches of the color chart, specifies a desired color patch, and specifies the identification information by the input unit 10e.

The processor 10a specifies the color patch based on the identification information specified by the user, specifies the color value and the usage amount of each color material of the color patch, and acquires it as the representative color of the spot color plate. That is, the color value or the usage amount of each color material is recorded in the header indicating the representative color of the spot color plate.

As a result, the user's settings are reflected in subsequent printing of the spot color plate. Specifically, when printing the spot color plate, the representative color is printed in the color of the color patch specified by the user. Colors other than the representative color are printed as colors with the density of the color patch specified by the user increased or decreased based on the gradation value associated with each pixel.

In the above configuration, when the reference color is specified, a warning is issued if the color conversion by the color conversion model 10c1 is inaccurate, so that the user can recognize whether or not the color value of the reference color corresponds to the specified usage amounts of color materials. Further, since the surrounding colors generated based on the color value etc. of the reference color are also affected by the color value etc. of the reference color, the user can recognize whether or not the surrounding colors on the color chart are colors varied with the variation range intended by the user.

### (2) PRINT CONTROL PROCESS

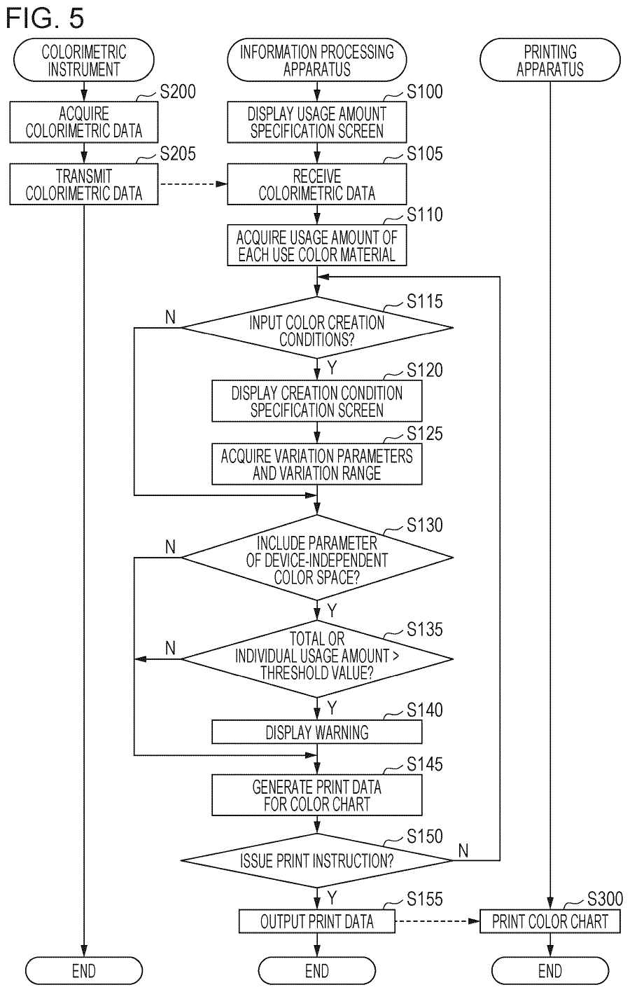

Next, the color chart print control process will be described in detail with reference to the flowchart shown in FIG. 5. The user prepares the image data 10c2 to be printed and stores it in the non-volatile memory 10c before starting the print control process. When starting printing, the user operates the input unit 10e of the information processing apparatus 10 to cause the processor 10a to execute the print control program.

When the print control program starts, the color information acquisition unit 10a1 controls the display unit 10d to display a usage amount specification screen (step S100). The usage amount specification screen is a screen for specifying the color value of the reference color and the usage amount of each color material used when the reference color is printed by the printing apparatus 30.

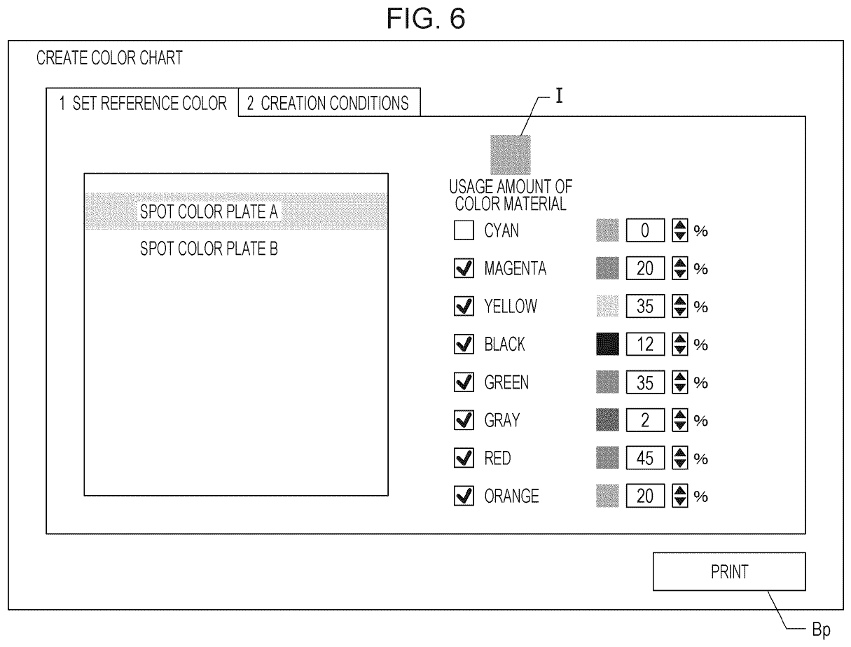

FIG. 6 illustrates an example of the usage amount specification screen. On this screen, a character string indicating that it is a screen for creating a color chart is displayed at the top, and the screen can be switched by two tabs shown below it. There are tabs for setting the reference color and for specifying color creation conditions. The screen shown in FIG. 6 illustrates a state where the tab for setting the reference color is selected, and this screen is the default display screen of the usage amount specification screen.

In the example illustrated in FIG. 6, a character string indicating the applicable spot color plate is displayed on the left side of the screen, and information on the reference color is displayed on the right side of the screen. On the left side of the screen, the spot color plates included in the image data 10c2 are listed, and the selected spot color plate is colored gray. On the right side of the screen, an icon I simulating the reference color is displayed at the top, and a user interface for specifying the usage amount of each color material is displayed at the bottom. The icon I simulating the reference color is a rectangular sample simulating the color corresponding to the color value indicating the reference color and is not displayed on the initial screen.

In the user interface for specifying the usage amount of each color material, the names of the color materials usable in the printing apparatus 30 are displayed in a list, and checkboxes for specifying whether or not to use each color material are associated with the names of the color materials. The color materials specified as color materials to be used by the checkboxes are referred to as use color materials. Icons simulating the colors of the color materials and input boxes indicating the usage amounts of the color materials are associated with the names of the color materials. The usage amount of each color material can be specified as any value from 0 to 100%, but no numerical value is displayed on the initial screen. In the present embodiment, the % value indicating the usage amount of each color material and the gradation value are associated with each other in advance. Naturally, the usage amount of each color material may be specified by a gradation value.

The user can specify the usage amounts of the color materials in various ways to specify the reference color, but in this example, the usage amount of each color material corresponding to the color value, which is the colorimetric result by the colorimetric instrument 20, is presented as an initial value. Therefore, the user operates the colorimetric instrument 20 to measure the sample color. When the colorimetric measurement is performed, the processor 20a of the colorimetric instrument 20 acquires the colorimetric data 20c1 (step S200) and stores it in the non-volatile memory 20c.

Next, the processor 20a of the colorimetric instrument 20 transmits the colorimetric data 20c1 to the information processing apparatus 10 via the communication unit 20b (step S205). By the function of the color information acquisition unit 10a1, the processor 10a of the information processing apparatus 10 receives the colorimetric data 20c1 via the communication unit 10b (step S105) and stores it in the non-volatile memory 10c. Furthermore, the processor 10a refers to the input-side model or the display profile of the color conversion model 10c1 and converts the HSV value indicated by the colorimetric data 20c1 into an RGB gradation value. The processor 10a then controls the display unit 10d (e.g., display) and displays the icon I with the RGB gradation value.

Next, the color information acquisition unit 10a1 acquires the usage amount of each use color material (step S110). The user determines the use color materials, operates the input unit 10e, and checks the checkboxes displayed on the right side of the usage amount specification screen illustrated in FIG. 6. According to this configuration, the user can specify all or part of the color materials usable in the printing apparatus 30 as use color materials. The color information acquisition unit 10a1 acquires the checked color materials as use color materials.

Furthermore, the color information acquisition unit 10a1 refers to the output-side model of the color conversion model 10c1 and converts the color value acquired in step S105 into the usage amount of each use color material under the constraint condition of using the use color materials and not using the color materials that are not use color materials. The color information acquisition unit 10a1 controls the display unit 10d and displays the usage amounts obtained by the conversion as initial values in the input boxes indicating the usage amounts of the color materials. In this state, the user can correct the usage amounts in the input boxes by operating the input unit 10e. When the usage amounts are corrected by the user, the color information acquisition unit 10a1 refers to the output-side model of the color conversion model 10c1, converts the usage amounts of each color material into a color value, and considers it as the color value of the reference color. Here, when the usage amounts are corrected by the user, that is, when the usage amounts of the color materials for printing the reference color are specified by the user, the usage amounts of the color materials may become excessive. For example, if the usage amounts of the color materials are excessive like the second usage amount, the usage amounts of the color materials exceed the usage amounts of the color materials corresponding to the gradation values of the learning range of the color conversion model 10c1 described above. As a result, even if the color chart is printed, the colors of the color patches included in the color chart may be different from the colors intended by the user.

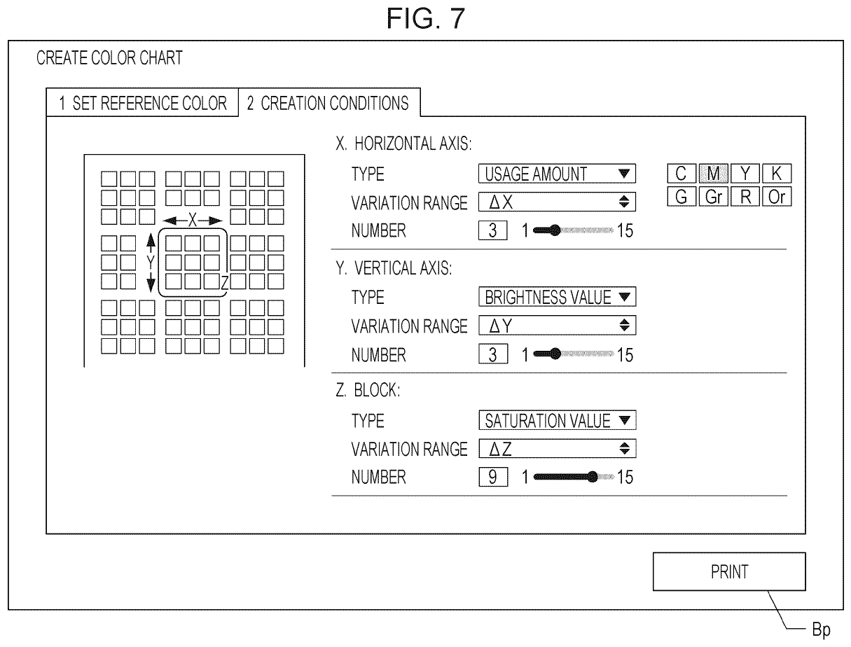

The user can select a tab for specifying color creation conditions on the usage amount specification screen illustrated in FIG. 6. The color information acquisition unit 10a1 determines whether or not the user has operated the input unit 10e and selected the tab for specifying the color creation conditions (step S115). If it is determined that the user has selected the tab for specifying the color creation conditions, the color information acquisition unit 10a1 displays a creation condition specification screen (step S120). FIG. 7 illustrates an example of the creation condition specification screen. In the example illustrated in FIG. 7, a diagram schematically illustrating the color chart is displayed on the left side of the screen, and a user interface for specifying creation conditions when varying the reference color to generate surrounding colors is displayed on the right side of the screen.

In the example illustrated in FIG. 7, the user interface is a screen for setting each of the three variation parameters. The letters X, Y, and Z are respectively associated with the three variation parameters. A type, a variation range, and a number are associated with each variation parameter, and the user can specify the content of each parameter. The type is the type of variation parameter, and by selecting the type, the user can specify which parameter of the color representing the reference color should be varied. In the present embodiment, the user can specify any three of the usage amounts of color materials, the hue value, the saturation value, and the brightness value as the variation parameters. Here, the hue value, saturation value, and brightness value are parameter values of the device-independent color space, while the usage amount of the color materials is a parameter value of the device-dependent color space. When the variation parameter is the usage amount of the color materials, the color of the color material to be varied can be selected. In the example illustrated in FIG. 7, magenta is selected.

The variation range is the amount of one step when varying the value of the variation parameter step by step. For example, the user can specify the variation range by a percentage of the usage amount, a hue value, or the like. The number indicates the number of color patches generated by varying the variation parameter. The user can specify the number using numerical values or a slide bar.

When the variation range and the number are specified, the configuration is determined in which the color patches are arranged. Specifically, the variation parameter associated with X is a parameter that varies when the position of the color patch varies in the horizontal direction, and the variation parameter associated with Y is a parameter that varies when the position of the color patch varies in the vertical direction. These X and Y correspond to the horizontal and vertical axes, and the color patches generated by varying the variation parameter associated with X are arranged horizontally by the number specified for the variation parameter. The color patches generated by varying the variation parameter associated with Y are arranged vertically by the number specified for the variation parameter.

The color patches arranged vertically and horizontally by the specified numbers as described above are called a block. For example, when the numbers are specified as 3 for both the variation parameter associated with X and the variation parameter associated with Y, 3 color patches are arranged vertically and horizontally in one block. In the example illustrated in FIG. 7, the block located in the center is surrounded by a solid line and displayed with the letter Z attached. The variation parameter associated with Z is a parameter that varies in different blocks. That is, the value of the variation parameter associated with Z is different for different blocks.

When such color patches are compared with each other, the variation parameters associated with X, Y, and Z each vary by the variation range. For example, the colors of horizontally adjacent color patches have a color difference of the variation range in the value of the variation parameter associated with X. The colors of vertically adjacent color patches have a color difference of the variation range in the value of the variation parameter associated with Y. Furthermore, by varying the value of the variation parameter associated with Z by the variation range, colors included in different blocks are generated.

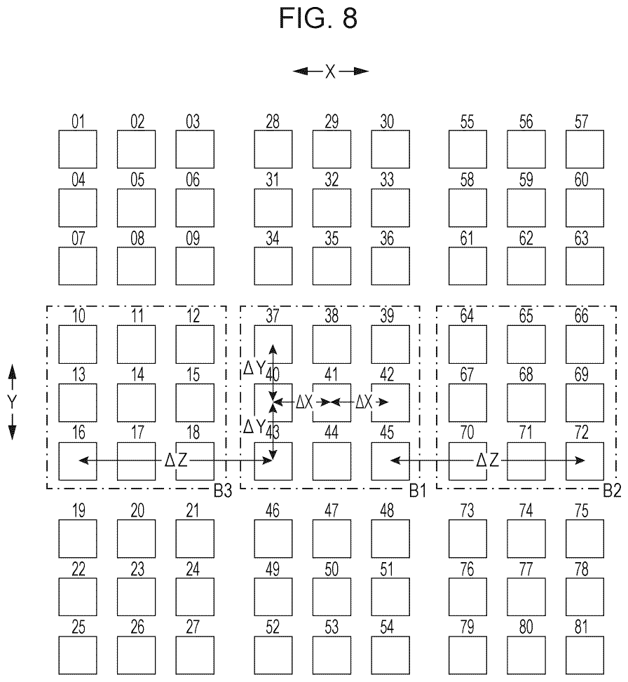

FIG. 8 illustrates an arrangement example of color patches generated when the settings for X, Y, and Z are the example illustrated in FIG. 7. In this example, since the numbers for X and Y are 3 and 3, respectively, the number of color patches arranged in one block is 9. In the example illustrated in FIG. 8, numerical values (01 to 81), which serve as identification information, are printed in association with each color patch.

In the color patches illustrated in FIG. 8, the color patch with the identification information 41 arranged in the center is the reference color color patch. The block B1 including the reference color is composed of 9 color patches. In the horizontal direction, the usage amount of magenta, which is the variation parameter associated with X, varies by the variation range ΔX. Therefore, for example, the color patch with the identification information 42 is printed with a magenta usage amount that is greater than that of the reference color by ΔX, and the color patch with the identification information 40 is printed with a magenta usage amount that is less than that of the reference color by ΔX.

In the vertical direction, the brightness value, which is the variation parameter associated with Y, varies by the variation range ΔY. Therefore, for example, the color patch with the identification information 37 is printed with a usage amount corresponding to a color value with a brightness value greater than that of the color patch with the identification information 40 by ΔY, and the color patch with the identification information 43 is printed with a usage amount corresponding to a color value with a brightness value less than that of the color patch with the identification information 40 by ΔY.

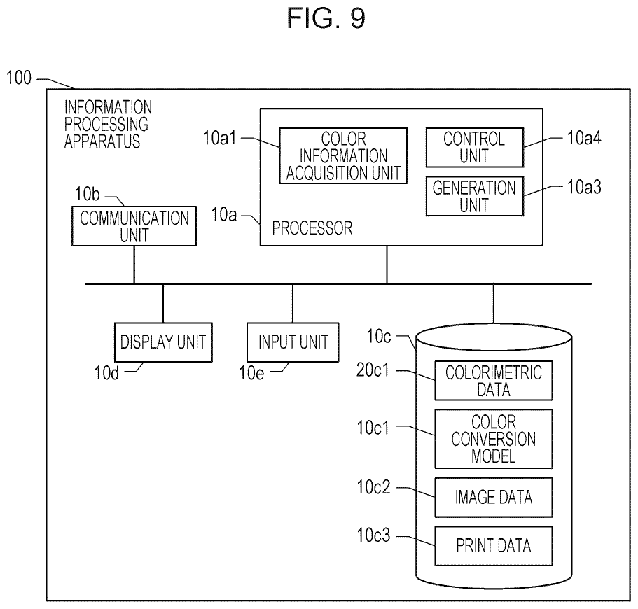

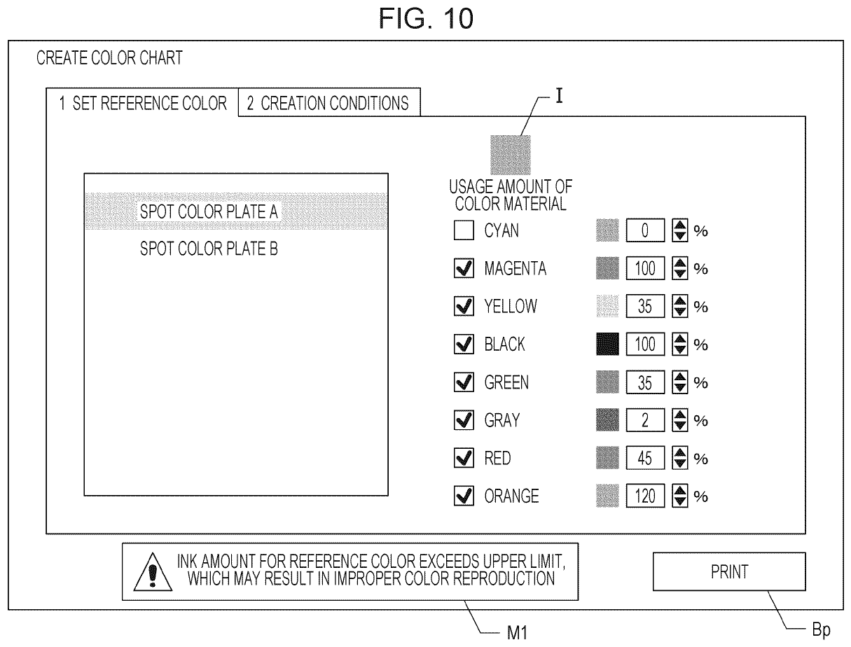

Further, in the color patches illustrated in FIGS. 8, 9 blocks are arranged, and in each block, the saturation value, which is the variation parameter associated with Z, varies by the variation range ΔZ. Therefore, for example, the color patch with the identification information 72 in the block B2 is printed with a usage amount corresponding to a color value with a saturation value greater than that of the color patch with the identification information 45 in the block B1 by ΔZ, and the color patch with the identification information 16 in the block B3 is printed with a usage amount corresponding to a color value with a saturation value less than that of the color patch with the identification information 43 in the block B1 by AZ. The dashed-dotted lines indicating the blocks, character strings B1, B2, B3, ΔX, ΔY, ΔZ, and arrows in FIG. 8 are for explanation and are not printed on the color chart.

As described above, the color chart illustrated in FIG. 8 includes the reference color and surrounding colors, but in the present embodiment, the user can also have only the reference color color patch printed. That is, the user can also have one reference color color patch printed using the usage amounts of each color material specified in step S110. In this case, the user does not select the tab for specifying the color creation conditions. Therefore, the processor 10a skips steps S120 and S125 after the determination in step S115.

When it is determined that the user has not selected the tab for specifying the color creation conditions, or when step S125 is executed, the warning unit 10a2 determines whether or not the variation parameters include a parameter of the device-independent color space (step S130). Specifically, when the variation parameters specified by the user in step S125 include at least one of the hue value, saturation value, and brightness value, the warning unit 10a2 determines that the variation parameters include a parameter of the device-independent color space. On the other hand, in step S125, when the user specifies only the usage amounts of color materials as variation parameters and does not specify any other variation parameter, the warning unit 10a2 determines that the variation parameters do not include a parameter of the device-independent color space. Further, when it is determined in step S115 that the user has not selected the tab for specifying the color creation conditions, the warning unit 10a2 also determines that the variation parameters do not include a parameter of the device-independent color space.

When it is determined in step S130 that the variation parameters include a parameter of the device-independent color space, the warning unit 10a2 determines whether or not at least one of the total usage amount of the color materials and the individual usage amount of each color material is greater than the threshold value (step S135). As described above, the threshold values for the total usage amount of the color materials and the usage amount of each color material are set in advance.

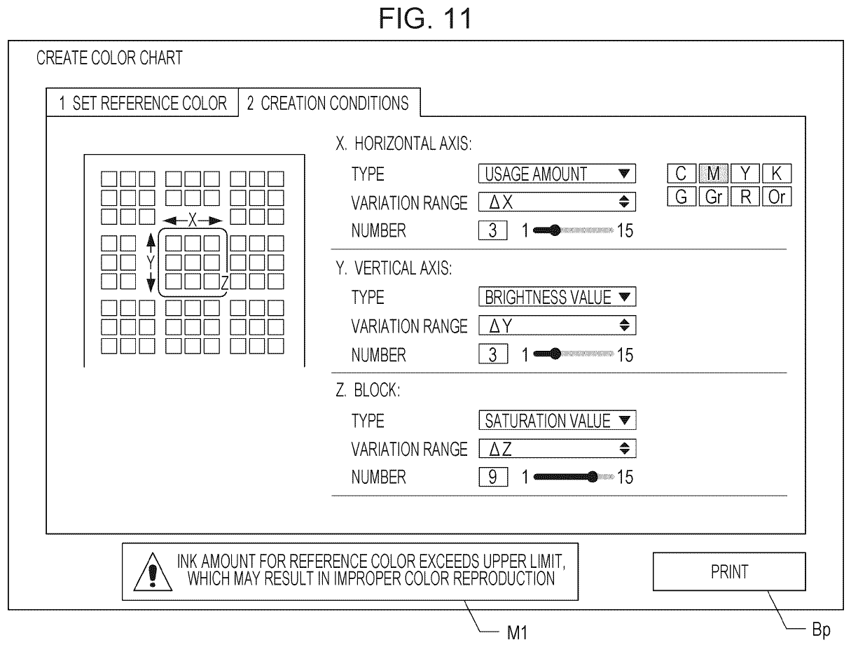

When it is determined in step S135 that at least one of the total usage amount of the color materials and the individual usage amount of each color material is greater than the threshold value, the warning unit 10a2 considers that the usage amounts of the color materials are the second usage amounts and subject to warning. Therefore, the warning unit 10a2 controls the display unit 10d and displays a warning (step S140). The content of the warning may be various and includes, for example, a message indicating that the usage amount of the color materials is excessive and a message indicating that the print medium will undulate with the specified usage amount. FIGS. 10 and 11 illustrate examples in which a message M1 indicating that the usage amounts of the color materials exceed the upper limit and appropriate colors are not reproduced is displayed in the examples illustrated in FIGS. 6 and 7.

On the other hand, if it is determined in step S135 that neither the total usage amount of the color materials nor the individual usage amount of each color material is greater than the threshold value, the warning unit 10a2 considers that the usage amounts of the color materials are the first usage amounts and not subject to warning. In this case, the warning unit 10a2 skips step S140. According to the above configuration, the user is warned when the specified usage amount is excessive, and the user can recognize that the usage amount is excessive.

When it is determined in step S130 that the variation parameters do not include a parameter of the device-independent color space, the warning unit 10a2 skips steps S135 and S140. As a result, no warning is issued. Therefore, in the present embodiment, when the variation parameters include the usage amounts of color materials but do not include a parameter of the device-independent color space, the warning unit 10a2 displays no warning regardless of whether the usage amount of the color materials is the first usage amount or the second usage amount.

As described above, in the present embodiment, when the variation parameters include a parameter of the device-independent color space, a warning is displayed according to the usage amount of the color materials; however, when the variation parameters do not include a parameter of the device-independent color space, a warning is not displayed regardless of the usage amount of the color materials. When the variation parameters include a parameter of the device-independent color space, surrounding colors are generated by varying the color value of the reference color, but the color value of the reference color is obtained by converting the usage amount of the color materials by the output-side model of the color conversion model 10c1. The accuracy of the conversion by the output-side model of the color conversion model 10c1 decreases when the usage amounts of the color materials are excessive. Therefore, when conversion by the output-side model of the color conversion model 10c1 is performed, that is, when the variation parameters include a parameter of the device-independent color space, a warning according to the usage amount can be issued.

However, when the variation parameters do not include a parameter of the device-independent color space, either surrounding colors are printed without conversion by the output-side model of the color conversion model 10c1 or only the reference color is printed. In any case, since no conversion is performed by the output-side model of the color conversion model 10c1, no warning is issued according to the usage amount. According to the above configuration, it is possible to provide a configuration that issues a warning when accuracy deterioration occurs due to the use of the output-side model of the color conversion model 10c1 and does not issue a warning when no accuracy deterioration occurs. Therefore, by not issuing a warning when no color conversion accuracy deterioration occurs, it is possible to prevent the user from feeling annoyed.

When it is determined in step S130 that the variation parameters do not include a parameter of the device-independent color space, or when it is determined in step S135 that neither the total usage amount of the color materials nor the individual usage amount of each color material is greater than the threshold value, or when step S140 is performed, the generation unit 10a3 generates print data 10c3 for the color chart (step S145). Specifically, the generation unit 10a3 generates image data of the color patches. When the creation conditions are not specified by the creation condition specification screen, the generation unit 10a3 generates image data for printing in an area of a predetermined size with the usage amount acquired in step S110.

When the creation conditions are specified by the creation condition specification screen, the generation unit 10a3 varies the reference color and generates surrounding colors according to the instructions on the creation condition specification screen. At this time, the generation unit 10a3 acquires the total number of color patches printed on the color chart based on the numbers specified for each of the three variation parameters corresponding to X, Y, and Z. The generation unit 10a3 then associates identification information with each of these color patches.

Furthermore, the generation unit 10a3 acquires the color value of the color patch of each identification information. That is, the generation unit 10a3 acquires the color value and the usage amount of each color material acquired in step S110 for the reference color. Furthermore, the generation unit 10a3 specifies the variation range of the variation parameter to be varied from the reference color and the number of times of variations with the variation range, based on the variation range specified in step S125.

For example, when generating the color patch with the identification information 45 in the example illustrated in FIGS. 7 and 8, the generation unit 10a3 specifies the usage amount when the usage amount of magenta of the reference color is increased once by the variation range ΔX. Furthermore, the generation unit 10a3 refers to the output-side model of the color conversion model 10c1 and converts the obtained usage amounts of each color material into a color value. Furthermore, the generation unit 10a3 decreases the obtained color value once by the variation range ΔY and considers it as the color value of the target color patch with the identification information 45. When the target patch is the color patch with the identification information 72, for example, the generation unit 10a3 increases the saturation value of the color patch with the identification information 45 once by the variation range ΔZ and considers it as the color value of the target color patch with the identification information 72.

As described above, when generating surrounding colors, when the variation parameters include a parameter of the device-independent color space, the usage amounts of the color materials in the reference color are converted into the parameter value of the device-independent color space, and the parameter is varied. Therefore, when the variation parameters include a parameter of the device-independent color space, conversion by the output-side model of the color conversion model 10c1 is involved. Therefore, in this case, the warning in step S140 can be executed according to the usage amounts of the color materials. Therefore, the user can recognize whether or not the usage amounts of the color materials are excessive, which degrades the conversion accuracy by the output-side model of the color conversion model 10c1.

Further, the generation unit 10a3 converts the color values into usage amounts of the color materials. That is, the generation unit 10a3 refers to the output-side model of the color conversion model 10c1 and converts the color values into usage amounts of color materials. Further, the generation unit 10a3 generates image data for printing uniform rectangular color patches of a predetermined size using each color material with the converted usage amount. Furthermore, the generation unit 10a3 arranges the images of all the color patches printed on the color chart in the order illustrated in FIG. 8. That is, the generation unit 10a3 arranges the color patches so that when the position varies to the next position in the horizontal direction, the variation parameter corresponding to X varies by the variation range, and when the position varies to the next position in the vertical direction, the variation parameter corresponding to Y varies by the variation range. In this way, blocks are formed. The generation unit 10a3 arranges the blocks so that the variation parameter corresponding to Z varies by the variation range between adjacent blocks. Furthermore, the generation unit 10a3 generates the print data 10c3 for printing each of the arranged color patches with the usage amount of each color material in each color patch.

Next, the generation unit 10a3 determines whether or not a print instruction has been issued (step S150). Specifically, when the user operates the input unit 10e and issues an instruction using the print button Bp illustrated in FIGS. 6 and 7, the generation unit 10a3 determines that a print instruction has been issued. If it is determined in step S150 that a print instruction has been issued, the generation unit 10a3 outputs the print data 10c3 (step S155). That is, the generation unit 10a3 outputs the print data 10c3 to the printing apparatus 30 via the communication unit 10b.

The processor 30a of the printing apparatus 30 acquires the print data 10c3 via the communication unit 30b and prints the color chart (step S300). The user selects a desired color patch from among the color patches printed on the color chart, operates the input unit 10e, and inputs the identification information of the selected color patch. The processor 10a considers that the representative color is specified by the color value and the usage amounts of color materials of the color patch corresponding to the input identification information. According to the above configuration, the desired color of the user can be set as the representative color of the spot color plate.

In the above configuration, if the user sets an excessive usage amount as the usage amount of the color material, a warning is issued, so that the user can know whether or not the accuracy of the color conversion when generating surrounding colors is decreasing due to the designation of the excessive usage amount.

### (3) OTHER EMBODIMENTS, ETC.

The above embodiments are merely examples for carrying out the present disclosure, and various other embodiments can be adopted. For example, the information processing apparatus 10 and other apparatuses (at least one of the colorimetric instrument 20 and the printing apparatus 30) may be provided integrally. The connection mode of each apparatus is not limited to the configuration illustrated in FIG. 1, and communication between arbitrary apparatuses may be performed via an arbitrary network. Furthermore, at least some of the functions of each apparatus may be distributed among multiple apparatuses; for example, at least some of the functions of the information processing apparatus 10 may be implemented by a cloud server. At least some of the functions of the information processing apparatus 10 may be implemented by other apparatuses to form an information processing system.

The color information acquisition unit only needs to be able to acquire the usage amount of the color materials when a reference color is printed by the printing apparatus based on input to a usage amount specification screen that specifies the usage amounts of the color materials. That is, the color information acquisition unit can receive the user's designation of the usage amounts of color materials via the usage amount specification screen and acquires the usage amount when printing the reference color through the usage amount specification screen. The color material may be any material that colors a print medium with a printing apparatus and is not limited to ink and may be toner or the like. The color materials usable in the printing apparatus can be distinguished by the colors (hues) of the color materials, but even if inks of the same color system have different shades and can be used separately, they may be distinguished as different color materials. When color materials are stored in cartridges, color materials stored in different cartridges may be distinguished as different color materials.

The usage amount of the color materials may be specified in various ways. It is not limited to the configuration specified by % as in the above embodiment and may be specified by gradation values or the like, or by a slide bar or the like. The reference color may be any color for which the user specifies the usage amounts of color materials and is not limited to the color representing the spot color plate. For example, a specific color included in the process color plate may be the reference color.

The warning unit only needs to be able to display no warning regarding the reproducibility of the reference color when the usage amount of the color materials is the first usage amount, and display a warning regarding the reproducibility of the reference color when the usage amount of the color materials is the second usage amount greater than the first usage amount. That is, the warning unit only needs to be able to display a warning when the second usage amount, which is an excessive amount compared to the first usage amount, is specified.

When specifying the usage amount of the color materials and performing printing, the user expects that the color printed with the specified usage amount will be the desired color. Therefore, if the printed color does not match the planned color, it can be said that the reproducibility is low. The reproducibility may be any index for evaluating the degree of matching between the printed color and the planned color. The configuration of indicating the reproducibility is not limited and may be indicated by a color difference or whether or not it is within a color gamut.

The warning unit may be configured so that no warning is issued when the first usage amount is specified, but a warning is issued when the second usage amount is specified. That is, a warning may be issued when a situation occurs in which the reproducibility is relatively lowered due to the excessive usage amount of the color materials.

The generation unit only needs to be able to acquire print data for printing a color chart including surrounding colors, which are colors generated by varying the value of the variation parameter in the reference color, and the reference color. That is, the generation unit only needs to be able to generate print data for printing a color chart including the reference color and surrounding colors. The surrounding colors are colors generated by varying a variation parameter, which is one of the parameters for specifying the color, with respect to the reference color. The variation parameter may be a parameter of a device-independent color space (e.g., CIELAB value, HSV value, XYZ value, etc.) or a parameter of a device-dependent color space (e.g., usage amount of each color material). The parameter may be any variable for specifying a color, and a color is specified by determining the values of multiple parameters. The number of parameters is assumed to be 3, for example, but a color may be specified by 4 or more parameters, such as the usage amounts of color materials.

Furthermore, the processing when the usage amounts of the color materials are excessive is not limited to issuing a warning. For example, the execution of printing may be prohibited when the usage amounts of the color materials are excessive. Such a configuration can be implemented by, for example, the information processing apparatus 100 illustrated in FIG. 9. The colorimetric instrument 20 and the printing apparatus 30 may have the same configuration as the configurations illustrated in FIGS. 2 and 3.

The information processing apparatus 100 illustrated in FIG. 9 has a configuration similar to that of the information processing apparatus 10 illustrated in FIG. 4, but some configurations are different. That is, a control unit 10a4 exists instead of the warning unit 10a2 as a function that can be implemented in the processor 10a. The control unit 10a4 has a function of enabling execution of printing of the reference color when the usage amount of the color materials is the first usage amount and prohibiting printing of the reference color when the usage amount of the color materials is the second usage amount greater than the first usage amount.

Specifically, the information processing apparatus 100 also executes the print control process similar to that in FIG. 5, but when it is determined in step S135 that at least one of the total usage amount of the color materials and the individual usage amount of each color material is greater than the threshold value, printing is prohibited. In this case, the processor 10a repeats the processing from step S115 onward without determining whether or not a print instruction has been issued in step S150. According to the above processing, the color chart cannot be printed when the user sets an excessive usage amount as the usage amount of the color material.

Furthermore, the above-described systems, programs, and methods may be implemented as a single apparatus or by using parts included in multiple apparatuses, and include various aspects. Further, they can be modified as appropriate, such as a part being software and a part being hardware. Furthermore, the disclosure also holds as a recording medium for a program for controlling an apparatus or system. Naturally, the recording medium for the program may be a magnetic recording medium, a semiconductor memory, or any recording medium developed in the future.

What is claimed is:

1. An information processing apparatus comprising:
a color information acquisition unit that acquires, based on input to a usage amount specification screen that specifies a usage amount of a color material, the usage amount of the color material when a reference color is printed by a printing apparatus; and
a warning unit that displays no warning regarding reproducibility of the reference color when the usage amount of the color material is a first usage amount, and displays a warning regarding reproducibility of the reference color when the usage amount of the color material is a second usage amount greater than the first usage amount.

2. The information processing apparatus according to claim 1, further comprising a generation unit, wherein
the color information acquisition unit acquires, among parameters that specify the reference color, variation parameters, which are parameters to be varied;
when the variation parameters include a parameter of a device-independent color space, the warning unit displays no warning when the usage amount of the color material is the first usage amount and displays a warning when the usage amount of the color material is the second usage amount; and
the generation unit generates print data for printing a color chart including a surrounding color, which is a color generated by varying values of the variation parameters in the reference color, and the reference color.

3. The information processing apparatus according to claim 2, wherein the warning unit, when the variation parameters include the usage amount of the color material and do not include a parameter of the device-independent color space, displays no warning when the usage amount of the color material is the first usage amount and displays no warning when the usage amount of the color material is the second usage amount.

4. The information processing apparatus according to claim 1, wherein the first usage amount and the second usage amount are a total usage amount of a plurality of the color materials used by the printing apparatus.

5. The information processing apparatus according to claim 2, wherein the generation unit, when the variation parameters include a parameter of a device-independent color space, converts the usage amount of the color material into a value of the parameter of the device-independent color space, varies the values of the variation parameters, and generates the surrounding color.

6. The information processing apparatus according to claim 5, wherein
the generation unit converts the usage amount of the color material into a value of the parameter of the device-independent color space by a color conversion model that is machine-learned to input the usage amount of the color material and output a value of the parameter of the device-independent color space, and
whether the usage amount of the color material is the second usage amount greater than the first usage amount is determined according to a learning range of the color conversion model.

7. An information processing apparatus comprising:
a color information acquisition unit that acquires, based on input to a usage amount specification screen that specifies a usage amount of a color material, the usage amount of the color material when a reference color is printed by a printing apparatus; and
a control unit that enables execution of printing of the reference color when the usage amount of the color material is a first usage amount, and prohibits printing of the reference color when the usage amount of the color material is a second usage amount greater than the first usage amount.

8. A non-transitory computer-readable storage medium storing an information processing program, the program causing a computer to function as:
a color information acquisition unit that acquires, based on input to a usage amount specification screen that specifies a usage amount of a color material, the usage amount of the color material when a reference color is printed by a printing apparatus; and
a warning unit that displays no warning regarding reproducibility of the reference color when the usage amount of the color material is a first usage amount, and displays a warning regarding reproducibility of the reference color when the usage amount of the color material is a second usage amount greater than the first usage amount.

9. A non-transitory computer-readable storage medium storing an information processing program, the program causing a computer to function as:
a color information acquisition unit that acquires, based on input to a usage amount specification screen that specifies a usage amount of a color material, the usage amount of the color material when a reference color is printed by a printing apparatus; and
a control unit that enables execution of printing of the reference color when the usage amount of the color material is a first usage amount, and prohibits printing of the reference color when the usage amount of the color material is a second usage amount greater than the first usage amount.
